(19) United States
(12) Patent Application Publication
(10) Pub. No.: US 2004/0176530 A1
(43) Pub. Date: Sep. 9, 2004

(54) Energy curable polymeric ink compositions

(76) Inventors: Michel Tielemans, Wemmel (BE); Dirk Bontinck, Ertvelde (BE); Vincent Renard, Couthuin (BE)

Correspondence Address: Wenderoth Lind & Ponack, Suite 800, 2033 K Street NW, Washington, DC, 20006, US

(21) Appl. No.: 10/483,676

(22) PCT Filed: Jul. 11, 2002
(86) PCT No.: PCT/EP02/07727

(30) Foreign Application Priority Data
Jul. 13, 2001 (EP) 01117099.0

(51) Int. Cl. C08G 18/00

(52) U.S. Cl. 524/589; 525/123

(57) ABSTRACT

The invention relates to an aqueous ink composition containing a polyurethane polymer and at least one colorant, wherein the colorant is covalently bonded to the polyurethane polymer, and the composition is crosslinkable to form a network containing the polyurethane polymer.

The present invention relates to aqueous ink compositions comprising colored polyurethanes which can be cured or crosslinked and more particular to aqueous ink compositions which can be crosslinked to yield a three-dimensional network after or during being applied to an appropriate substrate.

Water-based inks represent a growing market due to environmental pressure. Traditionally, such inks are made from the blend of a water-based polymeric binder (typically an acrylic latex made from emulsion polymerization) and a pigment dispersion in water obtained from the high shear grinding of the pigments in water with the tensio-active additive (dispersant and/or surfactant).

Furthermore, water-based inks are known which do not contain a pigment but contain a colorant instead. Such inks are particularly useful for ink jet applications, because ink jet printers require ink having a low viscosity and a low particle size, as well as thermostability. However, such inks must exhibit water-, solvent- and light-fastness. Clogging of the jetting channels as a result of pigment floculation, dye crystallization or water evaporation resulting in polymer drying at the nozzles should be avoided.

Recently, aqueous ink compositions have been developed which contain polymers on which the colorants are covalently bonded. In particular, polyurethane oligomers and polyurethane polymers which contain covalently bonded colorants have been developed and are used for this purpose. Corresponding colored polymers and/or ink compositions containing them are disclosed e.g. in U.S. Pat. No. 5,700,851, U.S. Pat. No. 5,864,002, U.S. Pat. No. 5,786,410, U.S. Pat. No. 5,919,846, U.S. Pat. No. 5,886,091 and EP-A 0 992 533.

U.S. Pat. No. 6,022,944 discloses colorants which can be blended uniformly into a variety of thermoplastic or thermosetting resins. However, thermosetting polyurethane polymers, on which a colorant is covalently bonded, are not disclosed in this document.

WO 00/31189 discloses solvent-free energy-curable inks including both a pigment and a colored rheological additive. This document does not disclose a thermosetting polyurethane dispersion on which a colorant is covalently bonded.

While the recently developed ink formulations already have advantages over previously known ink formulations, they are still not fully satisfactory, in particular if they are used in demanding high-tech applications such as ink jet applications, in-mould decorations, etc. It is therefore the object of the present invention to provide aqueous ink compositions which are particularly advantageous when used in such a high-tech application and which have a better performance than the known aqueous ink compositions in particular with respect to gloss, adhesion, water resistance, solvent resistance, scratch resistance, abrasion resistance, crinkle resistance and blocking resistance.

It is known by those skilled in the art that waterborne ink formulations derived from a polymer dispersion in water easily form a continuous film if the temperature is above the ‘minimum film formation temperature’ (MFFT). This phenomenon corresponds to the irreversible drying of the polymer composition that causes lots of troubles during the application of the ink by conventional techniques like flexography and heliography. It is even worse in the case of inkjet inks that block the nozzles of the print heads upon drying and interrupt the printing process. To circumvent these serious problems of productivity and reliability, the ink must exhibit a particular behaviour often referred to as ‘ressolublity’, meaning that ink will not dry and hinder the printing process. An improved ressolubility of the polymer is obtained with a sufficiently hydrophilic character associated with a low molecular weight. As a direct consequence, these polymers naturally show a worse water and solvent fastness once printed. The crosslinking of the polymer was found to be a good manner to associate at the same time good ressolubility and fastness of the ink.

This object is solved by aqueous ink compositions as defined in the claims.

The aqueous ink compositions of the present invention contain a polyurethane polymer to which at least one colorant is covalently bonded. The ink composition can be crosslinked to form a three-dimensional network in which the polyurethane polymer and thus also the colorant are covalently bonded. During application or preferably after application of the ink composition on a substrate the ink composition is treated with energy, preferably heat, in order to initiate the crosslinking reaction. The crosslinkability of the colored polyurethane polymer can be achieved by covalent inclusion of one or several additional functionality to the colored polymer, which makes possible the crosslinking of the polyurethane polymer. In this case, this mechanism is refered to as “self-crosslinking” in this specification. Another mean to achieve crosslinkability is to add an external curing agent having at least two functional groups able to react with the functional groups of the polyurethane polymer. In a preferred embodiment the crosslinking agent is a polymer which is capable to effect the crosslinking of the polyurethane polymer upon application of energy, preferably heat.

The inventors have found that an ink composition as disclosed in this specification after application and crosslinking has good optical properties, such as light-fastness and color development and excellent physical properties, such as water-fastness, solvent-fastness, rubbing and scratching resistance. Cross-linking results in a network that is three-dimensional in principle. Thus, there is a covalent attachment of the colorants to the polymeric matrix. The colorants cannot escape from the matrix without the cleavage of chemical bonds. Cross-linking and curing takes place preferably during or after the ink has been applied to the substrate and generally is a process which preferably can be initiated thermally.

The aqueous ink compositions of the present invention are based on a dispersion of a polyurethane polymer in aqueous medium, preferably water. In a preferred embodiment, the polyurethane polymer is obtained from a polyurethane prepolymer which is the reaction product of

(i) at least one organic compound containing at least two reactive groups which can react with isocyanates,

(ii) at least one polyisocyanate,

(iii) at least one reactive colorant having at least one reactive group capable of reacting with (i) or (ii) and

(iv) at least one compound which is capable to react with (i) or (ii) and which contains additional functional groups which are susceptible to a crosslinking reaction.

The polyurethane prepolymer generally contains terminal free isocyanate groups, because the polyisocyanate is used in excess, and the polyurethane polymer can be obtained from the polyurethane prepolymer by reaction with a capping agent such as water or a chain extender.

In another embodiment, the polyurethane polymer is obtained from the reaction of the above-mentioned polyurethane prepolymer with a capping agent which contains an additional functionality which is susceptible to a (self)crosslinking reaction. In this case the compound (iv) may be omitted.

The dispersion in water preferably also contains an external crosslinking agent which preferably is a functionalized oligomer or polymer other than the polyurethane polymer. The dispersion may also optionally contain an initiator for radical or cationic polymerization. Additionally, non-polymeric additives used in the art can be present and such additives are e.g. biocides, antioxidants, UV-stabilizers, wetting agents, humectants, foam control agents, waxes, thickening agents, leveling agents, coalescing agents, plasticizers, surfactants, etc.

The polyisocyanate used according to the present invention for the preparation of the polyurethane prepolymer (compound ii) may be an aliphatic, cycloaliphatic, aromatic or heterocyclic polyisocyanate or a combination thereof. As example for suitable aliphatic diisocyanates there may be mentioned 1,4-diisocyanatobutane, 1,6-diisocyanatohexane, 1,6-diisocyanato-2,2,4-trimethylhexane, and 1,12-diisocyanatododecane either alone or in combination. Particularly suitable cycloaliphatic diisocyanates include 1,3- and 1,4-diisocyanatocyclohexane, 2,4-diisocyanato-1-methyl-cyclohexane, 1,3-diisocyanato-2-methylcyclohexane, 1-isocyanato-2-(isocyanatometyl)-cyclopentane, 1,1′-methylenbis[4-isocyanatocyclohexane], 1,1′-(1-methylethylidene)bis[4-isocyanato-cyclohexane], 5-isocyanato-1-isocyanatomethyl-1,3,3-trimethylcyclohexane (isophorone diisocyanate), 1,3- and 1,4-bis(isocyanatomethyl)cyclohexane, 1,1′-methylene-bis[4-isocyanato-3-methylcyclohexane], 1-isocyanato-4(or 3)-isocyanatomethyl-1-methylcyclohexane either alone or in combination. Particularly suitable aromatic diisocyanates comprise 1,4-diisocyanatobenzene, 1,1′-methylenebis[4-isocyanatobenzene], 2,4-diisocyanato-1-mthylethylidene)bis[4-isocyanatobenzene], 1,3- and 1,4-bis[1-isocyanato-1-methylethyl)benzene, 1,5-naphtalene diisocyanate, either alone or in combination. Aromatic polyisocyanates containing 3 or more isocyanate groups may also be used such as 1,1′,1″-methylidynetris[4-isocyanatobenzene] and polyphenyl polymethylene polyisocyanates obtained by phosgenation of aniline/formaldehyde condensates.

The total amount of the organic polyisocyanate is not particularly restricted, but generally is in the range from 10 to 60 wt % of the polyurethane polymer, preferably from 20 to 50 wt % and more preferably from 30 to 40 wt %.

In a preferred embodiment said polyisocyanate is selected from cycloaliphatic polyisocyanates, especially preferred is the use of methylene-bis(cyclohexyl isocyanate).

The organic compounds containing at least two reactive groups which can react with isocyanates (compound i) are preferably polyols, but e.g. amines can also be used.

Suitable examples are polyester polyols, polyether polyols, polycarbonate polyols, polyacetal polyols, polyesteramide polyols, polyacrylate polyols, polythioether polyols and combinations thereof. Preferred are the polyester polyols, polyether polyols and polycarbonate polyols. These organic compounds containing at least two reactive groups which are enabled to react with isocyanates, preferably have a number average molecular weight within the range of 400 to 5.000.

Polyester polyols are particularly preferred and suitable polyester polyols which may be used comprise the hydroxyl-terminated reaction products of polyhydric, preferably dihydric alcohols (to which trihydric alcohols may be added) with polycarboxylic, preferably dicarboxylic acids or their corresponding carboxylic acid anhydrides. Polyester polyols obtained by the ring opening polymerization of lactones may also be used.

The polycarboxylic acids which may be used for the formation of these polyester polyols may be aliphatic, cycloaliphatic, aromatic and/or heterocyclic and they may be substituted (e.g. by halogen atoms) and saturated or unsaturated. As examples of aliphatic dicarboxylic acids, there may be mentioned, succinic acid, glutaric acid, adipic acid, suberic acid, azelaic acid, sebacic acid and dodecanedicarboxylic acid. As an example of a cycloaliphatic dicarboxylic acid, there may be mentioned hexahydrophthalic acid. Examples of aromatic dicarboxylic acids include isophthalic acid, terephthalic acid, ortho-phthalic acid, tetrachlorophthalic acids and 1,5-naphthalenedicarboxylic acid. Among the unsaturated aliphatic dicarboxylic acids which may be used, there may be mentioned fumaric acid, maleic acid, itaconic acid, citraconic acid, mesaconic acid and tetrahydrophthalic acid. Examples of tri- and tetracarboxylic acids include trimellitic acid, trimesic acid and pyromellitic acid.

The polyhydric alcohols which are preferably used for the preparation of the polyester polyols include ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, 1,4-cyclohexanedimethanol, ethylene oxide adducts or propylene oxide adducts of bisphenol A or hydrogenated bisphenol A. Triols or tetraols such as trimethylolethane, trimethylolpropane, glycerin and pentaerythritol may also be used. These polyhydric alcohols are generally used to prepare the polyester polyols by polycondensation with the above-mentioned polycarboxylic acids, but according to a particular embodiment they can also be added as such to the polyurethane prepolymer reaction mixture.

In a preferred embodiment the polyester polyol is made from the polycondensation of neopentylglycol and adipic acid. The polyester polyol may also contain an air-drying component such as a long chain unsaturated fatty acid.

Suitable polyether polyols comprise polyethylene glycols, polypropylene glycols and polytetramethylene glycols, or bloc copolymers theirof.

Suitable polycarbonate polyols which may be used include the reaction products of diols such as 1,3-propanediol, 1,4-butanediol, 1,6-hexanediol, diethylene glycol, triethylene glycol or tetraethylene glycol with phosgene, with diarylcarbonates such as diphenylcarbonate or with cyclic carbonates such as ethylene and/or propylene carbonate.

Suitable polyacetal polyols which may be used include those prepared by reacting glycols such as diethyleneglycol with formaldehyde. Suitable polyacetals may also be prepared by polymerizing cyclic acetals.

The total amount of these organic compounds containing at least two reactive groups which can react with isocyanates preferably ranges from 30 to 90 wt % of the polyurethane polymer, more preferably of from 45 to 65 wt %.

The at least one reactive colorant containing at least one reactive group capable of reacting with isocyanates (compound iii) is preferably chosen from Milliken's reactive colorants REACTINT YELLOW X15, REACTINT BLUE X17AB, REACTINT ORANGE X96, REACTINT RED X64, REACTINT VIOLET X80LT and REACTINT BLACK X41LV. Suitable colorants are disclosed e.g. in U.S. Pat. No. 4,284,729, U.S. Pat. No. 4,507,407, U.S. Pat. No. 4,751,254, U.S. Pat. No. 4,761,502, U.S. Pat. No. 4,775,748, U.S. Pat. No. 4,846,846, U.S. Pat. No. 4,912,203, U.S. Pat. No. 4,113,721 and U.S. Pat. No. 5,864,002. Preferred are the colorants disclosed in U.S. Pat. No. 5,864,002. Insofar as the definition and methods for producing the colorants are concerned, it is explicitly referred to the above documents.

In another embodiment, the compound (iii) may be used as a polyol constituent of above-mentioned polyesters and polycarbonates which can themselves be components of the polyurethane polymer.

In still another embodiment the at least one organic compound containing at least two reactive groups which can react with isocyanates (compound i) can be identical with the at least one reactive colorant having at least one nucleophilic functionality capable of reacting with isocyanates (compound iii) but, of course, an additional compound (i) may also be used.

The colorant is preferably used in a weight ratio of 1 to 40 wt % based on the total polyurethane polymer, more preferably from 5 to 20 wt %.

The compound which is capable to react with (i) or (ii) and which contains additional functional groups (compound iv) is preferably an alcohol or a polyol having pendant functionality. Such an alcohol or polyol typically contains water soluble side chains of ionic or non-ionic nature. Preferably, the polyol has functional groups such as anionic salt groups or similar precursors which may be subsequently converted to such anionic salt groups, such as carboxylic or sulfonic acid groups. It is also possible that the polyol comprises other functional groups which are susceptible to a crosslinking reaction, such as isocyanate, hydroxy, amine, acrylic, allylic, vinyl, alkenyl, alkinyl, halogen, epoxy, aziridine, aldehyde, ketone, anhydride, carbonate, silanol, acetoacetoxy, carbodiimide, ureidoalkyl, N-methylolamine, N-methylolamide N-alkoxy-methyl-amine, N-alkoxy-methyl-amide, or the like.

Compounds which are capable of reacting with (i) or (ii) and containing anionic salt groups (or acid groups which may be subsequently converted to such anionic salt groups) preferably are the compounds containing the dispersing anionic groups which are necessary to render the polyurethane prepolymer self dispersible in water e.g. sulfonate salt or carboxylate salt groups. According to the invention, these compounds are preferably used as reactants for the preparation of the isocyanate-terminated polyurethane prepolymer.

The carboxylate salt groups incorporated into the isocyanate-terminated polyurethane prepolymers generally are derived from hydroxycarboxylic acids represented by the general formula (HO)xR(COOH)y, wherein R represents a straight or branched hydrocarbon residue having 1 to 12 carbon atoms, and x and y independently are integers from 1 to 3. Examples of these hydroxycarboxylic acids include citric acid and tartaric acid. The most preferred hydroxycarboxylic acids are the α,α-dimethylolalkanoic acids, wherein x=2 and y=1 in the above general formula, such as for example, the 2,2-dimethylolpropionic acid. The pendant anionic salt group content of the polyurethane polymer may vary within wide limits but should be sufficient to provide the polyurethane with the required degree of water-dispersability and crosslinkability (if no other crosslinkable group is incorporated in the polyurethane polymer which provides the required crosslinkability). Typically, the total amount of these anionic salt group-containing compounds in the polyurethane polymer can range from 1 to 25 wt % of the polyurethane polymer, preferably from 4 to 10 wt %.

The sulfonate salt groups can be introduced in this prepolymer using sulfonated polyesters obtained by the reaction of sulfonated dicarboxylic acids with one or more of the above-mentioned polyhydric alcohols, or by the reaction of sulfonated diols with one or more of the above-mentioned polycarboxylic acids. Suitable examples of sulfonated dicarboxylic acids include 5-(sodiosulfo)-isophthalic acid and sulfoisophthalic acids. Suitable examples of sulfonated diols include sodiosulfohydroquinone and 2-(sodiosulfo)-1,4-butanediol.

Polyurethane polymers are generally produced by first preparing a polyurethane prepolymer by reacting polyisocyanate with organic compounds containing at least two reactive groups which can react with isocyanates, generally polyols. Reaction is carried out with excess of polyisocyanate, so that the prepolymer contains free isocyanate end groups which are then extended or capped. The polyurethane polymer is prepared from the polyurethane prepolymer containing free isocyanate groups by reacting the polyisocyanate prepolymer with a capping agent, wherein the capping agent is a well known agent used to inactivate the terminal isocyanate groups. The capping agent can e.g. be water or a usual chain extender. Generally, the colored polyurethane polymer which is used in the aqueous ink compositions of the present invention is produced accordingly.

The chain extender should carry active hydrogen atoms which react with the terminal isocyanate groups of the polyurethane prepolymer. The chain extender is suitably a water-soluble aliphatic, alicyclic, aromatic or heterocyclic primary or secondary polyamine having up to 80, preferably up to 12 carbon atoms.

When the chain extension of the polyurethane prepolymer is effected with a polyamine, the total amount of polyamine should be calculated according to the amount of isocyanate groups present in the polyurethane prepolymer in order to obtain a fully reacted polyurethane polymer (a polyurethane urea) with no residual free isocyanate groups; the polyamine used in this case may have an average functionality of 2 to 4, preferably 2 to 3.

In a preferred embodiment the chain extender is selected from aliphatic diamines, preferably it is 1,5-diamino-2-methyl-pentane.

The degree of non-linearity of the polyurethane polymer is controlled by the functionality of the polyamine used for the chain extension. The desired functionality can be achieved by mixing polyamines with different amine functionalities. For example, a functionality of 2.5 may be achieved by using equimolar mixtures of diamines and triamines.

Examples of such chain extenders useful herein comprise hydrazine, ethylene diamine, piperazine, diethylene triamine, triethylene tetramine, tetraethylene pentamine, pentaethylene hexamine, N,N,N-tris(2-aminoethyl)amine, N-(2-piperazinoethyl)ethylenediamine, N,N′-bis(2-aminoethyl)piperazine, N,N,N′-tris(2-aminoethyl)ethylenediamine, N-[N-(2-aminoethyl)-2-aminoethyl]-N′-(2aminoethyl)piperazine, N-(2-aminoethyl)-N′-(2-piperazino-ethyl)ethylenediamine, N,N-bis(2-aminoethyl)-N-(2-piperazinoethyl)amine, N,N-bis(2-piperazinoethyl)amine, guanidine, melamine, N-(2-aminoethyl)-1,3-propanediamine, 3,3′-diaminobenzidine 2,4,6-triaminopyrimidine, dipropylenetriamine, tetrapropylenepentamine, tripropylenetetramine, N,N-bis(6-aminohexyl)amine, N,N′-bis(3-aminopropyl)ethylenediamine, 2,4-bis(4′-aminobenzyl)aniline, 1,4-butanediamine, 1,6-hexanediamine, 1,8-octanediamine, 1,10-decanediamine, 2-methylpentamethylenediamine, 1,12-dodecane-diamine, isophorone diamine (or 1-amino3-aminomethyl-3,5,5-trimethyl-cyclohexane), bis(4-aminocyclohexyl)methane [or bis(aminocyclohexane-4-yl)-methane], and bis(4-amino-3-methylcyclohexyl)methane [or bis(amino-2-methylcyclohexane-4-yl)methane], alpha, omega-polypropyleneglycol-diamine-sulfopropylated sodium salts, polyethylene amines, polyoxyethylene amines and/or polyoxypropylene amines (e.g. Jeffamines from TEXACO).

The total amount of polyamines should be calculated according to the amount of isocyanate groups present in the polyurethane prepolymer. The ratio of isocyanate groups in the prepolymer to active hydrogens in the chain extender during the chain extension may be in the range of from about 1.0:0.7 to about 1.0:1.1, preferably from about 1.0:0.9 to about 1.0:1.02 on an equivalent basis.

The chain extension reaction is generally carried out at a temperature between 5° and 90° C., preferably between 10° to 50° C., and most preferably between 10° to 20° C.

In another embodiment of the present invention, the chain capping agent contains the reactive groups which are capable of effecting the crosslinking of the polyurethane polymer during or after application of the aqueous ink composition to the substrate. In this case, it is possible that the prepolymer is prepared by only three components and does not contain the at least one compound which is capable to react with an isocyanate group and which contains additional functional groups which are susceptible to a crosslinking reaction (compound iv), but, of course, such a compound may in addition also be used for preparing the prepolymer.

If the functional group which is susceptible to a crosslinking reaction is a sulfonate group, in a further preferred embodiment of the present invention, the sulfonate group can be incorporated into the polyurethane polymer by a chain extension using sulfonated diamines as chain extenders, like for example the sodium salt of 2,4-diamino-5-methylbenzenesulfonic acid or the sodium salt of sulfopropylated alpha, omega-polypropyleneglycol-diamine.

Any acid functionality which may be present in the polyurethane prepolymer can be converted to anionic salt groups by neutralization of said groups, before or simultaneously with the preparation of an aqueous dispersion of this prepolymer. The dispersion process of the polyurethane prepolymer is well known to those skilled in the art, and usually requires rapid mixing with a high shear rate type mixing head. Preferably, the polyurethane prepolymer is added to the water under vigorous agitation or, alternatively, water may be stirred into the prepolymer. A preferable process is disclosed e.g. in U.S. Pat. No. 5,541,251 to which it is referred for details.

Suitable neutralizing or quaternizing agents for converting the above mentioned acid groups into anionic salt groups during or before the dispersion in water of the polyurethane prepolymers bearing terminal isocyanate groups can be volatile organic bases and/or non-volatile bases. Volatile organic bases are those whereof at least about 90% volatilize during film formation under ambient conditions, whereas non-volatile bases are those whereof at least about 95% do not volatilize during film formation under ambient conditions.

Suitable volatile organic bases can be preferably selected from the group comprising ammonia, trimethylamine, triethylamine, triisopropylamine, tributylamine, N,N-dimethylcyclohexylamine, N,N-dimethylaniline, N-methylmorpholine, N-methylpiperazine, N-methylpyrrolidine and N-methylpiperidine. The trialkylamines are preferred.

Suitable non-volatile bases include those comprising monovalent metals, preferably alkali metals such as lithium, sodium and potassium. These nonvolatile bases may be used in the form of inorganic or organic salts, preferably salts wherein the anions do not remain in the dispersions such as hydrides, hydroxides, carbonates and bicarbonates.

Triethylamine is the most preferred neutralizing agent.

The total amount of these neutralizing agents should be calculated according to the total amount of acid groups to be neutralized. To ensure that all acid groups are neutralized in the case volatile organic bases are used, it is advisable to add the neutralizing agent in an excess of 5 to 30 wt %, preferably 10 to 20 wt %.

If desired, the compositions of the present invention may include other auxiliary substances (additives) which may be added to the final composition in order to impart or improve desirable properties or to suppress undesirable properties. These additives include known fillers, biocides (e.g. Acticide AS), antioxidants (e.g. Irganox 245), plasticizers (e.g. dioctyl phtalate), pigments, silica sols (e.g. Acemat TS100) and the known leveling agents (e.g. BYK 306), wetting agents (e.g. BYK 346), humectants (e.g. ethyleneglycol, 2-pyrrolidinone or 2-methyl-2,4-pentanediol), foam control agents (e.g. Dehydran 1293), thickening agents (e.g. Tilose MH6000), coalescing agents (e.g. Texanol), heat stabilizers, UV-light stabilizers (e.g. Tinuvin 328 or 622), transorbers, etc. The composition may also be blended with other polymer dispersions, for example, with polyvinyl acetate, epoxy resins, polyethylene, polystyrene, polybutadiene, polyvinyl chloride, polyacrylate and other homopolymer and copolymer dispersions.

The preparation of the polyurethane prepolymer bearing terminal isocyanate moieties can be carried out in conventional manner, by reacting a stoichiometric excess of the organic polyisocyanate(s) with the organic compound(s) containing at least two reactive groups which are enabled to react with isocyanate groups and the other reactive compound(s) which can react with isocyanates under substantially anhydrous conditions, preferably at a temperature between 50° C. and 120° C., more preferably between 60° C. and 95° C., until the reaction between the isocyanate groups and the reactive groups is substantially complete. This reaction may be facilitated by the addition of 5 to 40 wt %, preferably 10 to 20 wt % of a solvent, in order to reduce the viscosity of the prepolymer if this would appear to be necessary. Suitable solvents, either alone or in combination, are those which are non-reactive with isocyanate groups such as ketones, esters and amides such as N,N-dimethylformamide, N-cyclohexylpyrrolidine and N-methylpyrrolidone. The preferred solvents are the ketones and esters with a relatively low boiling point so that they can easily be removed before, during or after the chain extension by distillation under reduced pressure. Examples of such solvents include acetone, methyl ethyl ketone, diisopropyl ketone, methyl isobutyl ketone, methyl acetate and ethyl acetate.

In a preferred embodiment acetone is used as a solvent and stripped out under vacuum after the water dispersion step.

If desired, the preparation of the isocyanate-terminated polyurethane prepolymer may be carried out in the presence of any of the known catalysts suitable for polyurethane preparation such as amines and organometallic compounds. Examples of these catalysts include triethylenediamine, N-ethyl-morpholine, triethylamine, dibutyltin dilaurate, stannous octanoate, dioctyltin diacetate, lead octanoate, stannous oleate, dibutyltin oxide and the like.

During the preparation of the isocyanate-terminated polyurethane prepolymer the reactants are generally used in proportions corresponding to a ratio of isocyanate groups to such groups which are enabled to react with the isocyanate functionalities of from about 1.1:1 to about 4:1, preferably from about 1.3:1 to 2:1.

The aqueous ink composition containing a polyurethane polymer is preferably prepared by dispersing the polyurethane polymer in an aqueous medium such as water. Alternatively the prepolymer containing free isocyanate groups is prepared in an organic solvent followed by the addition of water to the prepolymer solution, until water becomes a continuous phase. To this aqueous dispersion of the polyurethane prepolymer the chain extender is added to form the polyurethane polymer. Localized amine concentration gradients are preferably avoided by previously forming an aqueous solution of the polyamine and adding slowly this solution to the polyurethane prepolymer dispersion. Then the solvent is eventually removed by distillation to form a pure aqueous dispersion of the polyurethane polymer.

If the functional groups which are susceptible to a crosslinking reaction and which are present in the polyurethane polymer or prepolymer are acidic groups which should be transferred to anionic groups, it can be preferable that the neutralizing reaction of the acidic groups is effected before the polyurethane polymer or prepolymer is dispersed into the aqueous medium. However, it is also possible that the aqueous medium into which the polyurethane polymer is dispersed contains the neutralizing agent.

The aqueous ink composition of the present invention may also contain at least one external crosslinking agent, especially if the functionality present on the polymer is not sufficient to provide self-crosslinking. The term “crosslinking agent” as used in the present specification is not restrictive and encompasses all kinds of compounds which can react with the polyurethane polymer, preferably with functional groups of the polyurethane polymer to form a three-dimensional network. Suitable crosslinking agents are known in the prior art. For example, if the polyurethane contains carboxyl groups as functional groups which are susceptible to a crosslinking reaction, the crosslinking agent can be a trifunctional aziridine compound or a melamine-formaldehyde resin, as it is described in U.S. Pat. No. 4,301,053 and U.S. Pat. No. 5,137,967, to which it is referred for details. If the additional functional groups which are susceptible to a crosslinking reaction are obtained by incorporating hydrazide groups into the polyurethane chain, the crosslinking agent can be formaldehyde, as described in U.S. Pat. No. 4,598,121, to which it is referred for details.

Since crosslinking agents such as aziridine compounds or formaldehyde are relatively toxic and have negative effects on the pot-life of the composition, it is preferred to use vinyl-type polymers as crosslinking agents. The term “vinyl-type” polymer as used in the present specification is not specifically restricted and should encompass all types of polymers obtainable by polymerization, preferably by free radical addition polymerization of a vinyl-type monomer.

The vinyl-type polymer may be prepared by any suitably free-radical initiated polymerisation technique, preferably by emulsion polymerization.

The vinyl-type polymers for use in the present invention may preferably have a weight average molecular weight within the range of 10,000 to 500,000.

The emulsion polymerisation of the monomers may be carried out according to known methods, for example by using a semi-batch process wherein a pre-emulsion of the above-mentioned monomers is introduced into a reactor containing an aqueous solution of a free-radical initiator and heated at a constant temperature of between 60° and 95° C., preferably between 75° and 85° C., for a period of 1 to 4, preferably 2 to 3 hours to complete the reaction.

The pre-emulsion of the monomers can be prepared by adding each monomer with stirring to an aqueous solution of an emulsifier, preferably an anionic type emulsifier, such as for example lauryl sulfate, dodecylbenzenesulfonate, dodecyldiphenyloxidedisulfonate, alkylphenoxypoly(ethyleneoxy)sulfates or dialkylsulfosuccinates, wherein the alkyl residue may have from 8 to 12 carbon atoms. Most preferably, a nonylphenoxypoly(ethyleneoxy)sulfate is used. It is to be understood that non-ionic emulsifiers may also be used.

Conventional free-radical initiators are used for the polymerisation of the monomers, such as for example hydrogen peroxide, tert-butylhydroperoxide, alkali metal persulfates or ammonium persulfate.

Vinyl-type monomers are generally ethylenically unsaturated, preferably monoethylenically unsaturated monomers. Preferred ethylenically unsaturated monomers which may be used for the formation of the vinyl-type polymer are selected from the group comprising

a) α,β-monoethylenically unsaturated carboxylic acid and their esters like alkyl acrylates and alkyl methacrylates, which have an alkyl residue of 1 to 12 carbon atoms, such as methyl methacrylate, methyl acrylate, ethyl acrylate, butyl acrylate, 2-ethylhexyl acrylate, isooctyl acrylate, nonyl acrylate and dodecyl acrylate,

b) α,β-monoethylenically unsaturated carboxylic acid and their functionalised esters like hydroxyalkyl acrylates and hydroxyalkyl methacrylates, which have an alkyl residue of 1 to 12 carbon atoms, such as hydroxyethyl acrylate, hydroxyethyl methacrylate,

c) vinyl substituted aromatic hydrocarbons such as styrene, α-methylstyrene and the like,

d) α,β-ethylenically unsaturated carbonamides such as acrylamide, methacrylamide, methoxymethylacrylamide, N-methylolacrylamide and the like,

e) vinyl esters of aliphatic acids such as vinyl acetate, vinyl versatate and the like (versatates are esters of tertiary monocarboxylic acids having C9, C10 and C11 chain length),

f) vinyl chloride and vinylidene chloride,

g) monoethylenically unsaturated sulfonates such as the alkali metal salts of styrene-sulfonic acid, 2-acrylamido-2-methyl-propanesulfonic acid, 2-sulfoethyl methacrylate, 3-sulfopropyl methacrylate and the like (internal surfactants).

Necessarily, at least one of said monomers must contain a functional group chosen between carboxylic and sulfonic acids, isocyanates, hydroxy, amine, acrylic, allylic, vinyl, alkenyl, alkinyl, halogen, epoxy, aziridine, aldehyde, ketone, anhydride, carbonate, silanol, acetoacetoxy, carbodiimide, ureidoalkyl, N-methylolamine, N-methylolamide N-alkoxy-methyl-amine, N-alkoxy-methyl-amide, or the like. Hence, the vinyl-type polymer contains functional groups which can bind to the crosslinkable reactive groups of the polyurethane polymer, so that crosslinking is achieved during or after application of the ink composition to the substrate. In particular, one of said monomers may be an α,β-monoethylenically unsaturated carboxylic acid, such as acrylic acid, methacrylic acid, itaconic acid or the like, and present in an amount of 0 to 30 wt % of the vinyl-type polymer.

In a preferred embodiment of the present invention, the monomer as described above contains acetoacetoxyalkyl ester functional groups. In a preferred embodiment, the vinyl-type monomers have the general formula R—O—CO—CH2-CO—CH3 wherein R represents a CH2=CR′—COO-R″-group or a CH2=CR′R″-group in which R′ is —H or —CH3, and R″ is an alkylene residue having 1 to 12 carbon atoms. The most preferred monomer of this type is acetoacetoxyethyl acrylate, acetoacetoxyethyl methacrylate.

The amount of the monoethylenically unsaturated monomer containing an acetoacetoxyalkyl ester group may generally vary from about 1 to about 80 wt %, preferably from about 5 to 50 wt % of the vinyl polymer.

Thus, the preferred crosslinking agent is a vinyl-type polymer comprising chain-pendant acetoacetoxyalkyl ester functional groups, preferably formed by the free-radical addition polymerisation of at least one monoethylenically unsaturated monomer containing an acetoacetoxyalkyl ester group with at least one other ethylenically unsaturated monomer as defined above.

Vinyl-type polymers containing chain-pendant functional acetoacetoxyalkyl ester groups and methods for producing such polymers are e.g. disclosed in U.S. Pat. No. 5,541,251 to which it is specifically referred for details of the polymers and the production process.

The vinyl-type polymer can be combined with the polyurethane polymer in an aqueous composition by dispersing both compounds in an aqueous medium, preferably water. This process is also described in U.S. Pat. No. 5,541,251 to which it is referred for details.

In one preferred embodiment the vinyl-type polymer is formed in situ by polymerizing one or more vinyl-type monomers in the presence of an aqueous polyurethane dispersion. Again it can be referred to U.S. Pat. No. 5,541,251 for details. Alternatively, it is also possible to prepare the polyurethane polymer in the presence of the vinyl-type polymer. Thus, in the most preferred embodiment of the present invention, the polyurethane polymer contains additional functional groups which are susceptible to a crosslinking reaction and which are an anionic salt group, preferably a group COOM or SO3M, wherein M represents an alkali metal or an ammoniumtetraalkylammonium or tetraalkylphosphonium group, as defined in U.S. Pat. No. 5,541,251 and the crosslinking agent is a vinyl-type polymer having chain-pendant acetoacetoxyalkyl ester functional groups, whereby crosslinking is effected at moderate temperatures during and/or after film-formation as disclosed in U.S. Pat. No. 5,541,251 to which document it is referred for details. These compositions have a remarkably long pot-life and do not require additional and potentially toxic crosslinking agents.

In a preferred embodiment of the present invention as described above, the aqueous ink composition preferably comprises the polyurethane polymer and the vinyl-type polymer in a weight ration of 1:10 to 10:1, more preferably of 1:4 to 4:1 and most preferably of 1:2 to 2:1.

The aqueous ink composition of the present invention can comprise other external crosslinking agents, e.g. polyfunctional molecules having reactive functionalities including carboxylic and sulfonic acids, isocyanates, hydroxy, amine, acrylic, allylic, vinyl, alkenyl, alkinyl, halogen, epoxy, aziridine, aldehyde, ketone, anhydride, carbonate, silane, acetoacetoxy, carbodiimide, ureidoalkyl, N-methylolamine, N-methylolamide N-alkoxy-methyl-amine, N-alkoxy-methyl-amide, or the like. These other crosslinking agents may be present in the aqueous ink composition alone or in combination with one another or with the vinyl-type polymer as discussed above. Which crosslinking agent should be used depends on the type of crosslinkable functionality in the polyurethane polymer and the crosslinking agent can be chosen by a skilled person accordingly.

The crosslinking agent and optional auxiliary substances or additives are included into the aqueous dispersion in a known manner.

The aqueous ink compositions suitably have a total solids content of from about 5 to 65 wt %, preferably from about 30 to 50 wt %, more preferably from 30 to 35 wt %; a viscosity measured at 25° C. of 50 to 5000 mPa s, preferably 100 to 500 mPa s, a pH value of 7 to 11, preferably of 7 to 9 and an average particle size of about 10 to 1000 nm, preferably 30 to 300 nm, more preferably 50 to 100 nm.

The film formation temperature may preferably range from 0 to 70° C., more preferably from 0 to 20° C.

The aqueous ink composition can be easily applied to any substrate including paper, cardboard, plastics, fabrics, glass, glass fibers, ceramics, concrete, leather, wood, metals and the like, for industrial or domestic purposes and by any conventional method including flexography or heliography, or eventually brushing, spraying and dipping.

The aqueous ink composition according to the current invention is preferably used in an ink-jet printer. Other known application techniques can also be used, such as in-mould decorations, etc.

After having been applied to the substrate, the deposited coatings are cured either at ambient temperature for a certain time (e.g. 3 days), or at a higher temperature for a shorter period of time. The crosslinking is preferably initiated using thermal energy. The cured coatings obtained therefore exhibit excellent adhesion, outstanding water and solvent resistance, mechanical strength, durability, flexibility and deep color.

Color matching can easily be obtained by blending the colored ink compositions in the appropriate manner; it is worth to mention that color matching can also be achieved by blending the colored reactive raw materials to use them as building blocks for the manufacture of the desired colored polymer.

Although the aqueous inks of the invention exhibit good color intensity, they can be mixed with pigment dispersions in order to correct or emprove the color definition, depth or durability.

It is possible to prepare different aqueous resin compositions according to the invention by making a judicious combination of the starting materials, thus allowing the chemical, physical and technological properties of said compositions to be modified as desired, in order to adjust them to their future applications. It is shown in detail in the examples.

### EXAMPLES

The isocyanate content in a prepolymer reaction mixture was measured using the dibutylamine back-titration method.

The viscosity η of the aqueous polymer dispersions was measured at 25° C. with a Brookfield RVT Viscometer, using spindle No. 1 at 50 rpm when the viscosity was under 200 mPa s or spindle No. 2 at 50 rpm when the viscosity was higher than 200 mPa s.

The average particle size of the aqueous polymer dispersions was measured by laser light scattering using a Malvern Particle Analyzer Processor types 7027 & 4600SM.

All measurements on the final coatings were carried out either on coating lines prepared with a drawing pen or using a Meyer bar in order to obtain the appropriate thickness.

The water fastness was assessed after 4μ coating on OPP (or Xerox transparency) with drying 5′ at 80° C. followed by 18 h immersion in tap water at 20° C. The ranking is the result of the tape adhesion and the scratch resistance. A 1-5 scale is used, 5=best.

The solvent resistance of the coatings were evaluated after the printing of lines with a drawing pen on Xerox transparency with drying 1′ at 80° C. followed by 24H at room temperature. The ranking is the result of double rubs with a piece of cotton rag saturated with isopropanol, until the film fell. One rub was equal to a forward and backward stroke. The reported number was the number of rubs required to break through the coating.

The scratch resistance of the coatings were assessed after the printing of lines with a drawing pen on Xerox transparency with drying 1′ at 80° C. followed by 24H at room temperature. The ranking is the result of the damage observed after scratching the print with the nail using forward and backward motion. A 1-5 scale is used, 5=best.

The gel content of the aqueous resin compositions was assessed in order to determine if crosslinking had occurred by using a basket immersed for 10 seconds into the composition to be tested, dried at 110° C. during 5 minutes, weighed and then immersed in N,N-dimethylformamide (DMF) for 24 hours at ambient temperature. The basket was removed from the solvent and dried at ambient temperature for 12 hours, then at 110° C. for 5 minutes and then weighed again. The reported gel content was the ratio, expressed in %, of the weight of the coatings measured after 24 hours immersion in the solvent with respect to the weight of the coating measured before immersion in the solvent, i.e. the % coating weight retained on the basket after the immersion in the solvent. CL Example 1

### Red-Colored Polyurethane Dispersion

A double-wall glass reactor equipped with a mechanical stirrer, a thermocouple, a vapor condenser and a dropping funnel was charged with 262.0 g of N-methylpyrrolidone, 158.2 g of a polyester having an average molecular weight ˜670 Daltons and obtained by the polycondensation of adipic acid and neopentylglycol, 30.6 g of cyclohexane dimethanol, 45.9 g of dimethylol propionic acid, 73.8 g of REACTINT RED X64 (Milliken), 429.5 g of methylene bis(cyclohexyl isocyanate) and 1.0 g of dibutyltinlaurate as reaction catalyst. The reaction mixture was heated up to 90° C. with stirring, and the condensation process was maintained until the isocyanate content reached 1.46 meq/g. The polyurethane prepolymer was cooled down to 50° C., and 34.6 g of triethylamine were added as neutralizing agent until homogenous solution occurred. This polymer solution was transferred into a dispersing vessel containing 1624.0 g of water at room temperature, and equipped with a Cowless-type mixing unit ensuring vigorous mixing. After about 5 minutes of stirring, the dispersion of the polymer was complete and 85.2 g of 2-methylpentanediamine were added dropwise as a chain extender. After about 1 hour, the aqueous dispersion of a fully reacted polyurethane-urea was filtered on a 100μ sieve to deliver a deeply-colored stable product. It had a dry content of 30.4%, a viscosity of 80 mPa s, a pH of 8.4, a particle size of 36 nm and a grits content of <100 mg/l.

### Example 2

### Yellow-Colored Polyurethane Dispersion

A double-wall glass reactor equipped with a mechanical stirrer, a thermocouple, a vapor condenser and a dropping funnel was charged with 262.0 g of N-methylpyrrolidone, 156.1 g of a polyester having an average molecular weight ˜670 Daltons and obtained by the polycondensation of adipic acid and neopentylglycol, 39.2 g of cyclohexane dimethanol, 45.3 g of dimethylol propionic acid, 73.8 g of REACTINT YELLOW X15 (Milliken), 423.6 g of methylene bis(cyclohexyl isocyanate) and 1.0 g of dibutyltinlaurate as reaction catalyst. The reaction mixture was heated up to 90° C. with stirring, and the condensation process was maintained until the isocyanate content reached 1.44 meq/g. The polyurethane prepolymer was cooled down to 50° C., and 34.6 g of triethylamine were added as neutralizing agent until a homogenous solution occurred. This polymer solution was transferred into a dispersing vessel containing 1536.3 g of water at room temperature, and equipped with a Cowless-type mixing unit ensuring vigorous mixing. After about 5 minutes of stirring, the dispersion of the polymer was complete and 82.9 g of 2-methylpentanediamine were added dropwise as a chain extender. After about 1 hour, the aqueous dispersion of a fully reacted polyurethane-urea were filtered an a 100μ sieve to deliver a deeply-colored stable product. It had a dry content of 30.7%, a viscosity of 74 mPa s, a pH of 8.5, a particle size of 35 nm and a grits content of <100 mg/l.

### Example 3

### Blue-Colored Polyurethane Dispersion

A double-wall glass reactor equipped with a mechanical stirrer, a thermocouple, a vapor condenser and a dropping funnel was charged with 262.0 g of N-methylpyrrolidone, 158.9 g of a polyester having an average molecular weight ˜670 Daltons and obtained by the polycondensation of adipic acid and neopentylglycol, 28.1 g of cyclohexane dimethanol, 46.1 g of dimethylol propionic acid, 73.8 g of REACTINT BLUE X17AB (Milliken), 431.2 g of methylene bis(cyclohexyl isocyanate) and 1.0 g of dibutyltinlaurate as reaction catalyst. The reaction mixture was heated up to 90° C. with stirring, and the condensation process was maintained until the isocyanate content reached 1.46 meq/g. The polyurethane prepolymer was cooled down to 50° C., and 34.7 g of triethylamine were added as neutralizing agent until a homogenous solution occurred. This polymer solution was introduced in a dispersing vessel containing 1515.0 g of water at room temperature, and equipped with a Cowless-type mixing unit ensuring vigorous mixing. After about 5 minutes of stirring, the dispersion of the polymer was complete and 67.3 g of 2-methylpentanediamine were added dropwise as a chain extender. After about 1 hour, the aqueous dispersion of a fully reacted polyurethane-urea was filtered on a 100μ sieve to deliver a deeply-colored stable product. It had a dry content of 31.3%, a viscosity of 84 mPa s, a pH of 7.7, a particle size of 36 nm and a grits content of <100 mg/l.

### Example 4

### Red-Colored Polyurethane Dispersion

A double-wall glass reactor equipped with a mechanical stirrer, a thermocouple, a vapor condenser and a dropping funnel was charged with 290.0 g of a polyester (average molecular weight ˜670 Daltons; obtained by the polycondensation of adipic acid and neopentylglycol & 1,4-butanediol 1:1 (moles)), 182 g of another polyester (average molecular weight ˜700 Daltons; obtained by the polycondensation of adipic acid and 1,4-butanediol), 50.3 g of dimethylol propionic acid, 100.0 g of REACTINT RED X64 (Milliken), 5.1 g of trimethylolpropane 372.1 g of methylene bis(cyclohexyl isocyanate) and 1.0 g of dibutyltinlaurate as reaction catalyst. The reaction mixture was heated up to 90° C. with stirring, and the condensation process was maintained until the isocyanate content reached 1.03 meq/g. The polyurethane prepolymer was cooled down to 50° C., and 32.2 g of triethylamine & 11.0 g of 2-dimethylamino-2-methyl-1-propanole as a 80% water solution were added as neutralizing agent until a homogenous solution occurred. This polymer solution was introduced in a dispersing vessel containing 1922.1 g of water at room temperature, and equipped with a Cowless-type mixing unit ensuring vigorous mixing. After about 5 minutes of stirring, the dispersion of the polymer was complete and 46.0 g of 1,3 bis(aminomethyl)cyclohexane and 12.2 g of propylenediamine were added dropwise as a chain extender. After about 1 hour, the aqueous dispersion of a fully reacted polyurethaneurea was filtered on a 100μ sieve to deliver a deeply-colored stable product. It had a dry content of 35.1%, a viscosity of 130 mPa s, a pH of 9.3, a particle size of 27 nm and a grits content of <100 mg/l.

### Example 5

### Reactive Acrylic Dispersion

28.6 g of an aqueous solution of sodium nonylphenylpoly(oxyethylene)sulfate with n=10 (solids content of 34 wt %) and 28.6 g of an aqueous solution of nonylphenoxypoly-(oxyethylene) with n=30 (solids content of 70 wt %) and 5.0 g of the potassium salt of 3-sulfopropyl methacrylate were introduced with stirring in a tank containing 290.0 g of demineralized water. Then, 550.0 g of methyl methacrylate, 385.0 g of 2-ethylhexyl acrylate, 50.0 g of acetoacetoxyethyl methacrylate and 15.0 g of acrylic acid were added thereto with strong stirring, and resulting in the formation of a preemulsion. 2.4 g of ammonium persulfate were added with stirring to a reactor containing 4.3 g of the above-mentioned aqueous solution of nonylphenylpoly(oxyethylene)sulfate in 720.0 g of demineralized water and heated up to 80° C. The pre-emulsion prepared above was then added into the resulting mixture over a period of 2.5 hours. The reactor was maintained at 80° C. for 2 hours to complete the reaction and then allowed to cool to room temperature. 10.0 g of a 25% (w/w) aqueous solution of ammonia were added slowly thereto. The resulting latex had a dry content of 48.6%, a viscosity of 232 mPa s, a pH of 6.0, an average particle size of 133 nm, a free monomer content of below 0.01 wt % (controlled by gas chromatography), a grits content below 50 mg/l and a minimal film forming temperature of about 20° C.

### Example 6

### Non-Reactive Acrylic Dispersion

The procedure was identical to that described in Example 5, but the starting materials for the pre-emulsion were replaced with 575.0 g of methyl methacrylate, 410.0 g of 2-ethylhexyl acrylate and 15.0 g of acrylic acid. The resulting latex had a dry content of 48.0%, a viscosity of 315 ma s, a pH of 8.5, an average particle size of 134 nm, a free monomer content of below 0.01 wt %, a grits content below 50 mg/l and a minimal film forming temperature of about 17° C. This vinyl polymer had no acetoacetoxyalkyl ester functional groups.

The colored polyurethane dispersions prepared in examples 1 to 4 have been tested for their performance with and without thermal crosslinking. The crosslinking was obtained either with a polyaziridine crosslinker (UCECOAT M2 refered as “M2” in table 1) or with the acrylic dispersions of example 5. The dispersions were applied using a “drawing-pen” or a Meyer bar at various thickness on polyester and polypropylene (1 minute at 80° C.) or cardboard (room temperature). The prints were allowed to stand 24 hours at room temperature. The ink made from the above polymers exhibited a deep and glossy color, had a tack-free character before cure and good water fastness—together with scratch resistance. The performance was quite improved in each case when crosslinking took place. The results of the tests are summarized in the following table.

TABLE 1
crosslingking effect of colored-PUDs

| | | | water | | |
|---|---|---|---|---|---|
| M2 in | Crosslinking | Gel % | fastness | IPA fastness | Scratch |
| weight % | yes/no | DMF 5′100° C. | 1-5, 5 = good | Double rubs | 1-5, 5 = good |
| EX. 1 (red) | no | 0.7 | 1 | 60 | 1 |
| EX. 1 (red) + M2 | yes | 47.5 | 4 | 60 | 2 |
| at 2% | | | | | |
| EX. 2 | no | 0.8 | 1 | 50 | 1 |
| (yellow) | | | | | |
| EX. 2 | yes | 54.5 | 3 | 60 | 2 |
| (yellow) + M2 | | | | | |
| at 2% | | | | | |
| EX. 3 (blue) | no | 0.3 | 1 | 40 | 1 |
| EX. 3 (blue) + M2 | yes | 63.8 | 3 | 50 | 2 |
| at 2% | | | | | |
| EX. 4 (red) | no | 0 | 3 | 30 | 4 |
| EX. 4 (red) + M2 | yes | 58.5 | 5 | 60 | 4 |
| at 2% | | | | | |

IPA = isopropanol

TABLE 2
crosslinking effect of colored polyurethane: acrylic
hybrid dispersions 1:1 (dry/dry)

| Blends 1:1 | | | water | | |
|---|---|---|---|---|---|
| in dry | Crosslinking | Gel % | fastness | IPA fastness | Scratch |
| weight | yes/no | DMF 5′110° C. | 1-5, 5 = good | Double rubs | 1-5, 5 = good |
| EX. 1 (red) | no | 0 | 1 | 20 | 5 |
| EX. 6 | | | | | |
| EX. 1 (red) | yes | 40.4 | 1 | 20 | 5 |
| EX. 5 | | | | | |
| EX. 2 | no | 0.5 | 1 | 10 | 5 |
| (yellow) | | | | | |
| EX. 6 | | | | | |
| EX. 2 | yes | 41.5 | 2 | 20 | 5 |
| (yellow) | | | | | |
| EX. 5 | | | | | |
| EX. 3 (blue) | no | 0.7 | 1 | 20 | 5 |
| EX. 6 | | | | | |
| EX. 3 (blue) | yes | 38.2 | 1 | 20 | 5 |
| EX. 5 | | | | | |
| ex. 4 (red) | no | 0.4 | 1 | 10 | 5 |
| EX. 6 | | | | | |
| EX. 4 (red) | yes | 48.8 | 2 | 20 | 5 |
| EX. 5 | | | | | |

IPA = isopropanol

1. Aqueous ink composition containing a polyurethane polymer with a colorant, wherein the colorant is covalently bonded to the polyurethane polymer, and the composition is crosslinkable to form a network containing the polyurethane polymer.

2. Aqueous ink composition according to claim 1 wherein the polyurethane polymer is prepared from a polyurethane prepolymer, wherein the polyurethane prepolymer is the reaction product of
(i) at least one organic compound containing at least two reactive groups which can react with isocyanates
(ii) at least one polyisocyanate
(iii) at least one reactive colorant having at least one reactive group capable of reacting with (i) or (ii) and
(iv) at least one compound which is capable to react with (i) or (ii) and which contains additional functional groups which are susceptible to a crosslinking reaction.

3. Aqueous ink composition according to claim 2, wherein the group which is susceptible to crosslinking is an anionic salt group or an acid group which is convertible to an anionic salt group.

4. Aqueous ink composition according to claim 1 or 2, additionally containing an external crosslinking agent.

5. Aqueous ink composition according to claim 4, wherein the crosslinking agent is at least one vinyl-type polymer having reactive functional groups.

6. Aqueous ink composition according to claim 4 or 5, wherein the reactive functional group is an acetoacetoxyalkyl ester group.

7. Aqueous ink composition according to claims 4 to 6, wherein the vinyl-type polymer having acetoacetoxyalkyl ester functional groups is prepared by radical emulsion polymerization in the presence of the polyurethane polymer or prepolymer or wherein the polyurethane polymer or prepolymer is prepared in the presence of the vinyl-type polymer having acetoacetoxyalkyl ester functional groups.

8. Aqueous ink composition according to any of claims 1 to 7, wherein the colorant is selected from REACTINT YELLOW X15, REACTINT BLUE X17AB, REACTINT ORANGE X96, REACTINT RED X64, REACTINT VIOLET X80LT and REACTINT BLACK X41IV.

9. Aqueous ink composition according to any of claims 1 to 8, wherein the composition has a polymer dry content from 5 to 50%.

10. Aqueous ink composition according to any of claims 2 to 9, wherein the polyurethane polymer is prepared by reacting the polyurethane prepolymer with at least one capping agent or chain extension agent, optionally bearing a functional group capable of a crosslinking reaction.

11. Use of an aqueous ink composition according to any of claims 1 to 10 for coating a substrate by flexography, heliography, brushing, spraying or dipping.

12. Use according to claim 11, wherein the aqueous ink composition is for ink jet applications.

13. Method of coating a substrate, wherein an aqueous ink composition according to any of claims 1 to 10 is applied to the substrate and cured during application or after application on the substrate.

14. Method according to claim 13, wherein the aqueous ink composition is applied to the substrate by an ink jet printer.

15. Substrate being at least partially coated by a cured aqueous ink composition according to any of claims 1 to 10.
